(19) United States
(12) Patent Application Publication
(10) Pub. No.: US 2024/0164577 A1
(43) Pub. Date: May 23, 2024

(54) Cooking Appliance Comprising A Collection Device Configured To Collect Cooking Juices And Condensates

(71) Applicant: SEB S.A., Ecully (FR)

(72) Inventors: Marie Dussart, Ecully Cedex (FR); Johann Petitallot, Ecully Cedex (FR)

(73) Assignee: SEB S.A., Ecully (FR)

(21) Appl. No.: 18/512,521

(22) Filed: Nov. 17, 2023

(30) Foreign Application Priority Data
Nov. 17, 2022 (FR) 2211942

(51) Int. Cl. A47J 37/06; A47J 27/04; F24C 15/14

(52) U.S. Cl. CPC A47J 37/0664; A47J 27/04; F24C 15/14; A47J 2027/043

(57) ABSTRACT

A cooking appliance includes a cooking chamber; a cooking plate that can be moved between a first plate position and a second plate position; and a collection device configured to collect cooking juices from food on the cooking plate and having a collection tray located underneath the cooking plate. The cooking plate includes a drainage port opening into an internal volume of the cooking plate and located plumb with the collection tray, the drainage port being configured to allow the cooking juices contained in the internal volume to drain into the collection tray regardless of the position of the cooking plate.

### TECHNICAL FIELD

The present invention generally relates to a cooking appliance for cooking food products, and in particular to an oven-type multifunction cooking appliance using at least the meat grilling function and/or the steam cooking function.

### STATE OF THE ART

The use of oven-type electric cooking appliances to cook food in several cooking modes is known in the prior art. A collection tray, such as a drip pan for example, is generally present underneath the food to be cooked, which may, for example, be placed on a cooking rack, in order to collect the juices that drip from the food as it cooks.

There are also other technical alternatives for collecting juices and liquids produced when food is cooked, such as the use of a cooking vessel as a collection pan or the use of a partially airtight container for steam cooking.

However, the cooking appliances described above have certain drawbacks.

Indeed, when using a drip pan and while the food is cooking, the cooking juices drip from the food to be cooked into the drip pan. However, when the user is handling the food to be cooked outside or partially outside of the oven's inner space, for example after having partially moved the cooking rack supporting the food outside the oven, the cooking juices continue to flow from food to be cooked and drip onto the oven door in particular.

Moreover, the use of a cooking vessel configured to receive the food to be cooked has the major drawback of keeping the food to be cooked in contact with the cooking juices. In fact, the cooking juices will pool at the bottom of the cooking vessel holding the food to be cooked, which can alter both the cooking process and the organoleptic qualities of the food to be cooked.

### SUMMARY OF THE INVENTION

The technical problem behind the invention is to provide a cooking appliance that is ergonomic and easy to use and that enables food products to be cooked in a grill configuration but also in a steam cooking configuration, while preventing the food products from steeping in the cooking juices and/or condensates throughout the cooking step.

To this end, the present invention relates to a cooking appliance configured for cooking food, the cooking appliance comprising a cooking chamber, a cooking plate that can be moved in a direction of travel between a first plate position in which the cooking plate is located entirely within the cooking chamber and a second plate position in which the cooking plate is stopped at the end of a withdrawal movement and located at least partly outside the cooking chamber, the cooking plate comprising a bottom part and peripheral walls delimiting an internal volume, characterized in that the cooking appliance further comprises a collection device configured to collect cooking juices from food on the cooking plate, the collection device comprising a collection tray located underneath the cooking plate, and in that the cooking plate comprises a drainage port opening into the internal volume and located plumb with the collection tray, the drainage port being configured to allow the cooking juices contained in the internal volume to drain into the collection tray regardless of the position of the cooking plate.

This configuration of the cooking plate ensures that the cooking juices from the food on the cooking plate drain towards the collection device, and more specifically, to the collection tray. As a result, the food does not steep in the cooking juices while it is cooking.

Moreover, the specific configuration of the collection device makes it possible to collect the cooking juices from the cooking plate regardless of the position of the cooking plate. This keeps the cooking juices from dripping unchecked, for example onto the door of the cooking appliance, when the user moves the cooking plate to the second plate position, for example to check the doneness of the food. The second position corresponds to the position at which the cooking plate stops moving when the user withdraws the cooking plate from the cooking chamber in the direction of travel.

The cooking appliance can also have one or more of the following features, which can be taken alone or in combination.

According to an embodiment of the invention, the cooking plate is slidably mounted relative to a frame of the cooking appliance. More specifically, the cooking plate is slidably mounted between the first plate position and the second plate position in the direction of travel.

According to an embodiment of the invention, the bottom part of the cooking plate comprises at least one sloping guide surface that is configured to guide and direct the cooking juices contained in the internal volume towards the drainage port.

According to an embodiment of the invention, the at least one sloping guide surface is configured to be sloped relative to the horizontal at an angle of inclination comprised between 0° and 1°, and advantageously between 0.1° and 0.6°, and for example by approximately 0.3°, when the cooking appliance is resting on a horizontal surface.

According to an embodiment of the invention, the drainage port is provided on a peripheral wall of the cooking plate that extends substantially parallel to the direction of travel.

According to an embodiment of the invention, the at least one sloping guide surface is configured to be sloped relative to the horizontal around an axis that is transverse to the direction of travel.

According to an embodiment of the invention, the cooking plate comprises supporting ribs provided on the bottom part and configured to support food placed on the cooking plate.

According to an embodiment of the invention, the supporting ribs extend substantially transversely to the direction of travel.

According to an embodiment of the invention, the supporting ribs delimit cooking juice drainage channels configured to guide and direct at least part of the cooking juices contained in the internal volume towards the drainage port.

According to an embodiment of the invention, the cooking juice drainage channels extend transversely, and for example perpendicularly, to the direction of travel.

According to an embodiment of the invention, the cooking juice drainage channels are configured to guide and direct the cooking juices contained in the internal volume towards the peripheral wall of the cooking plate, which is provided with the drainage port.

According to an embodiment of the invention, the cooking plate further comprises a side collection channel configured to collect the cooking juices dripping into the cooking juice drainage channels and to guide and direct said cooking juices towards the drainage port.

According to an embodiment of the invention, each cooking juice drainage channel comprises a bottom wall that has a sloping guide surface configured to guide and direct the cooking juices contained in said cooking juice drainage channel towards the side collection channel.

According to an embodiment of the invention, the side collection channel comprises a bottom wall that is sloping and that is configured to guide and direct the cooking juices contained in the side collection channel towards the drainage channel.

According to an embodiment of the invention, the side collection channel extends along the peripheral wall of the cooking plate, which is provided with the drainage port.

According to an embodiment of the invention, the drainage port is located at the lowest point of the internal volume when the cooking appliance is resting on a horizontal surface.

According to an embodiment of the invention, the direction of travel is substantially horizontal when the cooking appliance is resting on a horizontal surface.

According to an embodiment of the invention, the side collection channel extends parallel to the direction of travel.

According to an embodiment of the invention, the cooking chamber comprises an access opening and the cooking appliance comprises a door that can be moved between a closed position in which the door closes the access opening and prevents access to the cooking plate, and an open position in which the door frees up the access opening and allows the cooking plate to be moved between the first plate position and the second plate position.

According to an embodiment of the invention, the door is pivotally mounted around a pivot axis that is substantially horizontal when the cooking appliance is resting on a horizontal surface.

According to an embodiment of the invention, the door's pivot axis extends substantially perpendicular to the direction of travel.

According to an embodiment of the invention, the cooking appliance further comprises a fixed separating component arranged between the collection tray and the cooking plate when the cooking plate is in the first plate position, the separating component comprising a through slot configured to allow the cooking juices to drain through the drainage port and towards the collection tray, regardless of the position of the cooking plate.

According to an embodiment of the invention, the separating component forms the bottom of the cooking chamber.

According to an embodiment of the invention, the through slot extends in a lengthwise direction that is substantially parallel to the direction of travel, so that the drainage port is located plumb with the through slot regardless of the position of the cooking plate.

According to an embodiment of the invention, the separating component delimits a collection volume configured to collect at least part of the condensates trickling down the inner walls of the cooking chamber.

According to an embodiment of the invention, the separating component has peripheral guide surfaces extending around the perimeter of the collection volume, the peripheral guide surfaces being configured to guide and direct at least part of the condensates trickling down the inner walls of the cooking chamber towards the collection volume.

According to an embodiment of the invention, each peripheral guide surface is configured to be sloped relative to the horizontal when the cooking appliance is resting on a horizontal surface.

According to an embodiment of the invention, the collection volume comprises a bottom wall that extends at least in part opposite the collection tray, the bottom wall comprising a drainage port configured to allow the condensates contained in the collection volume to drain into the collection tray.

According to an embodiment of the invention, the drainage port is provided at the lowest point of the bottom wall of the collection volume.

According to an embodiment of the invention, the cooking appliance further comprises a heating element arranged between the separating component and the cooking plate when the cooking plate is in the first plate position. Advantageously, the separating component acts as a heat shield; the presence of the separating component prevents the juices dripping into the collection tray from evaporating and burning due to the heat.

According to an embodiment of the invention, the cooking chamber comprises two deflection components provided respectively on two side walls of the cooking chamber, each deflection component being configured to extend at least in part above the cooking plate and to guide and direct the condensates trickling down the respective side wall of the cooking chamber towards the cooking plate.

According to an embodiment of the invention, each deflection component is configured to allow the condensates flowing over said deflection component to flow onto the cooking plate.

According to an embodiment of the invention, each deflection component is formed by a deflecting protrusion provided on the respective side wall of the cooking chamber.

According to an embodiment of the invention, the cooking plate further comprises two side edges extending substantially parallel to the direction of travel, each deflection component being configured to extend at least in part above a respective side edge and to allow the condensates flowing over said deflection component to drain onto the respective side edge.

According to an embodiment of the invention, each of the cooking plate's side edges is configured to be sloped relative to the horizontal when the cooking appliance is resting on a horizontal surface.

According to an embodiment of the invention, each deflection component has a drainage side that is substantially vertical and that is located plumb with the respective side edge of the cooking plate.

According to an embodiment of the invention, each deflection component is elongated and extends substantially parallel to the direction of travel.

According to an embodiment of the invention, each deflection component is configured to extend substantially horizontally when the cooking appliance is resting on a horizontal surface.

According to an embodiment of the invention, each deflection component is configured to extend along the entire length of the cooking plate when the cooking plate is in the first plate position. “Length of the cooking plate” refers to the cooking plate dimension measured in the direction of travel.

The present invention further relates to a cooking appliance configured for cooking food, the cooking appliance comprising a cooking chamber and a cooking plate located in the cooking chamber, characterized in that the cooking chamber comprises two deflection components provided respectively on two side walls of the cooking chamber, each deflection component being configured to extend at least in part above the cooking plate and to guide and direct condensates trickling down the respective side wall of the cooking chamber towards the cooking plate.

### BRIEF DESCRIPTION OF THE FIGURES

The present invention will be clearly understood from the following description with reference to the appended figures, in which identical reference signs correspond to structurally and/or functionally identical or similar elements.

FIG. 1 is a partial perspective front view of a cooking appliance according to the present invention, in which a cooking plate is in a first plate position;

FIG. 2 is a partial perspective front view of the cooking appliance in FIG. 1, in which the cooking plate is in a second plate position;

FIG. 3 is a partial cross-sectional view of the cooking appliance in FIG. 1;

FIG. 4 is a partial side view of the cooking appliance in FIG. 1, showing the cooking plate in the first plate position;

FIG. 5 is a partial side view of the cooking appliance in FIG. 1, showing the cooking plate in the second plate position;

FIG. 6 is a partial cross-sectional view of the cooking appliance in FIG. 1;

FIG. 7 is a partial perspective top view of the cooking appliance in FIG. 1 showing a heating element of the cooking appliance.

### DETAILED DESCRIPTION

FIGS. 1 to 7 show a cooking appliance 1 according to an embodiment of the invention. The cooking appliance 1 is configured for cooking food, such as meat, fish, vegetables or other food products.

The cooking appliance 1 comprises a cooking chamber 2, a cooking plate 3, a heating element 4, and a door 5 configured to close an access opening 6 of the cooking chamber 2. The cooking appliance 1 further comprises a collection device 7 configured to collect cooking juices from food on the cooking plate 3. The collection device 7 comprises a collection tray 8 located underneath the cooking plate 3.

More specifically, the cooking plate 3 is slidably mounted relative to a frame 9 of the cooking appliance 1 along a direction of travel A1, between a first plate position in which the cooking plate 3 is located entirely within the cooking chamber 2, and a second plate position in which the cooking plate 3 is stopped at the end of a withdrawal movement and located at least in part outside the cooking chamber 2. Advantageously, the direction of travel A1 is substantially horizontal when the cooking appliance 1 is resting on a horizontal surface.

The door 5 of the cooking appliance 1 can be moved between a closed position in which the door 5 closes the access opening 6 and prevents access to the cooking plate 3, and an open position in which the door 5 frees up the access opening 6 and allows the cooking plate 3 to be moved between the first plate position and the second plate position. For example, the door 5 is pivotally mounted around a pivot axis that extends substantially perpendicular to the direction of travel A1 and is substantially horizontal when the cooking appliance 1 is resting on a horizontal surface.

The cooking plate 3 comprises a bottom part 10 and peripheral walls 11 that delimit an internal volume 12. The cooking plate 3 further comprises supporting ribs 13 provided on the bottom part 10 and configured to support food placed on the cooking plate 3. Advantageously, the supporting ribs 13 extend transversely, and for example perpendicularly, to the direction of travel A1, and delimit cooking juice drainage channels.

The cooking plate 3 further comprises a drainage port 14 that opens into the internal volume 12 and is located plumb with the collection tray 8. The drainage port 14 is configured to allow the cooking juices contained in the internal volume 12 to drain into the collection tray 8, regardless of the position of the cooking plate 3.

According to the embodiment of the invention shown in the Figures, the drainage port 14 is provided on a peripheral wall 11 of the cooking plate 3 that extends substantially parallel to the direction of travel A1. Advantageously, and for optimal collection of the cooking juices, the drainage port 14 is located at the lowest point of the internal volume 12 when the cooking appliance 1 is resting on a horizontal surface.

More specifically, each cooking juice drainage channel comprises a bottom wall that is formed by the bottom part 10 of the cooking plate 3 and has a sloping guide surface 15 configured to guide and direct the cooking juices contained in said cooking juice drainage channel towards the peripheral wall 11 of the cooking plate 3, which is provided with the drainage port 14.

Advantageously, each sloping guide surface 15 is configured to be sloped relative to the horizontal at an angle of inclination comprised between 0° and 1°, and advantageously between 0.1° and 0.6°, and for example by approximately 0.3°, when the cooking appliance 1 is resting on a horizontal surface. Each sloping guide surface 15 is more specifically configured to be sloped relative to the horizontal around an axis transverse to the direction of travel A1.

The cooking plate 3 further comprises a side collection channel 16 configured to collect the cooking juices dripping into the cooking juice drainage channels and to guide and direct said cooking juices towards the drainage port 14. The side collection channel 16 extends along the peripheral wall 11 of the cooking plate 3 that has the drainage port 14, and parallel to the direction of travel A1. Advantageously, the sloping guide surface 15 of each cooking juice drainage channel is configured to guide and direct the cooking juices contained in said cooking juice drainage channel towards the side collection channel 16.

The side collection channel 16 comprises a bottom wall that is configured to be sloped relative to the horizontal and that is configured to guide and direct the cooking juices contained in the side collection channel 16 towards the drainage port 14.

According to the embodiment shown in the figures, the cooking appliance 1 further comprises a fixed separating component 17, that is arranged between the collection tray 8 and the cooking plate 3 when the cooking plate 3 is in the first plate position. Advantageously, the heating element 4 is arranged between the separating component 17 and the cooking plate 3 when the cooking plate 3 occupies the first plate position. Thus the separating component 17 acts as a heat shield and prevents the juices dripping into the collection tray 8 from evaporating and burning due to the heat.

The separating component 17 comprises a through slot 18 that extends in a lengthwise direction that is substantially parallel to the direction of travel A1 and that is configured to allow the cooking juices to drain through the drainage port 14 and towards the collection tray 8, regardless of the position of the cooking plate 3.

According to the embodiment shown in the figures, the separating component 17 forms the bottom of the cooking chamber 2 and delimits a collection volume 19 configured to collect at least part of the condensates trickling down the inner walls 20 of the cooking chamber 2. Advantageously, the separating component 17 comprises peripheral guide surfaces 21 extending around the perimeter of the collection volume 19. The peripheral guide surfaces 21 are configured to guide and direct at least part of the condensates trickling down the inner walls 20 of the cooking chamber 2 towards the collection volume 19. To this end, each peripheral guide surface 21 is configured to be sloped relative to the horizontal when the cooking appliance 1 is resting on a horizontal surface.

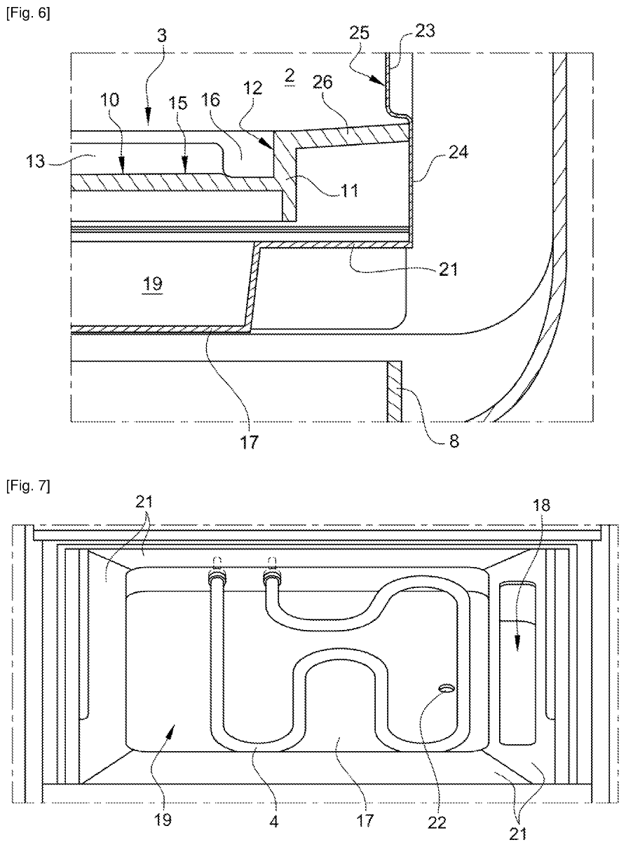

The collection volume 19 comprises a bottom wall that extends in part opposite the collection tray 8. The bottom wall comprises a drainage port 22 (see FIG. 7) that is configured to allow the condensates contained in the collection volume 19 to drain into the collection tray 8. Advantageously, the drainage port 22 is located at the lowest point of the bottom wall of the collection volume 19.

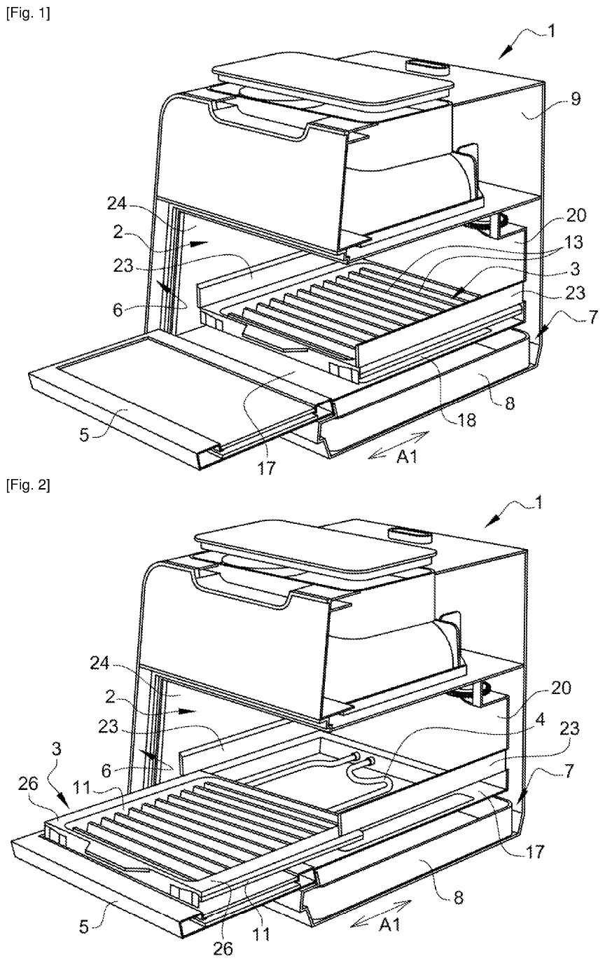

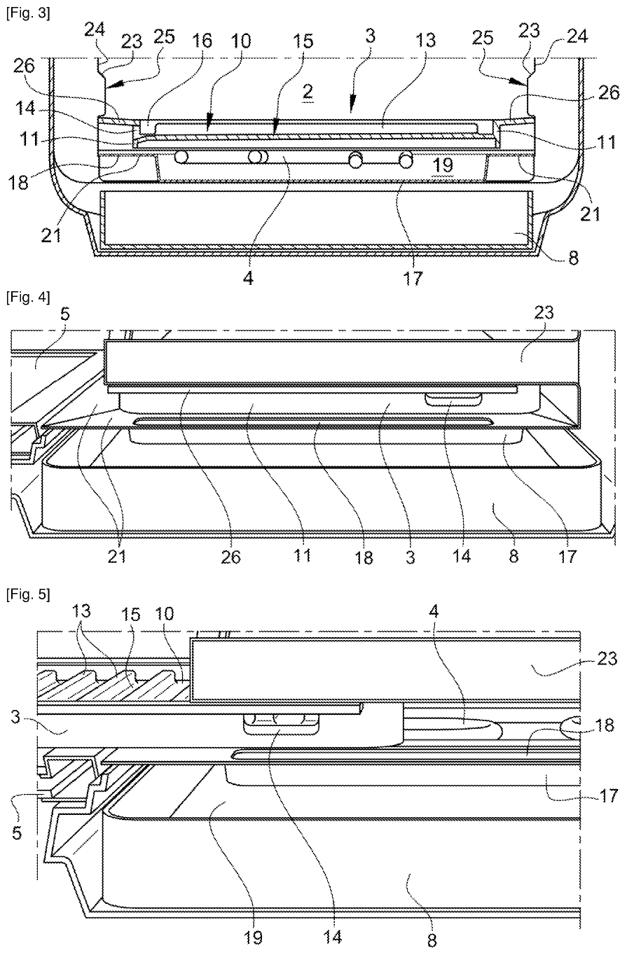

As shown more specifically in FIGS. 2 and 3, the cooking chamber 2 comprises two deflection components 23 provided respectively on two side walls 24 of the cooking chamber 2. Each deflection component 23 is configured to extend at least in part above the cooking plate 3 and to guide and direct the condensates trickling down the respective side wall 24 of the cooking chamber 2 towards the cooking plate 3.

According to the embodiment of the invention shown in the figures, each deflection component 23 is formed by a deflecting protrusion provided on the respective side wall 24 of the cooking chamber 2. Advantageously, each deflection component 23 is elongated and extends substantially parallel to the direction of travel A1, and therefore substantially horizontally when the cooking appliance is resting on a horizontal surface. For example, each deflection component 23 can be configured to extend along the entire length of the cooking plate 3 when the cooking plate is in the first plate position. Advantageously, each deflection component 23 comprises a drainage side 25 that is substantially vertical.

The cooking plate 3 also comprises two side edges 26 that extend substantially parallel to the direction of travel A1. Each deflection component 23 is configured to extend in part above a respective side edge 26 and to allow the condensates flowing over said deflection component 23 to drain onto the respective side edge 26. Advantageously, the side edges 26 of the cooking plate 3 are configured to be sloped relative to the horizontal when the cooking appliance 1 is resting on a horizontal surface.

Of course, the present invention is by no means limited to the embodiments described and illustrated, which have only been provided by way of example. Further changes are possible, particularly with regard to the composition of the various components or through the substitution of technical equivalents, without necessarily departing from the scope of protection of the invention.

1. A cooking appliance 1) configured for cooking food, the cooking comprising:
a cooking chamber;
a cooking plate that can be moved in a direction of travel between a first plate position in which the cooking plate -is located entirely within the cooking chamber and a second plate position in which the cooking plate -is stopped at the end of a withdrawal movement and located at least partly outside the cooking chamber, the cooking plate comprising a bottom part and peripheral walls delimiting an internal volume (12); and
a collection device configured to collect cooking juices from food on the cooking plate, the collection device comprising a collection tray located underneath the cooking plate, and in that the cooking plate comprises a drainage port opening into the internal volume and located plumb with the collection tray, the drainage port being configured to allow the cooking juices contained in the internal volume to drain into the collection tray regardless of the position of the cooking plate.

2. The cooking appliance according to claim 1, wherein the bottom part of the cooking plate comprises at least one sloping guide surface configured to guide and direct cooking juices contained in the internal volume towards the drainage port.

3. The cooking appliance according to claim 1, wherein the drainage port is provided on a peripheral wall of the cooking plate that extends substantially parallel to the direction of travel.

4. The cooking appliance according to claim 1, wherein the cooking plate comprises supporting ribs provided on the bottom part and configured to support food placed on the cooking plate.

5. The cooking appliance according to claim 4, wherein the supporting ribs delimit cooking juice drainage channels configured to guide and direct at least part of the cooking juices contained in the internal volume towards the drainage port.

6. The cooking appliance according to claim 5, wherein the cooking juice drainage channels are configured to guide and direct the cooking juices contained in the internal volume towards the peripheral wall of the cooking plate provided with the drainage port.

7. The cooking appliance according to claim 5, wherein the cooking plate further comprises a side collection channel configured to collect the cooking juices dripping into the cooking juice drainage channels and to guide and direct said cooking juices towards the drainage port.

8. The cooking appliance according to claim 7, wherein each cooking juice drainage channel comprises a bottom wall that has a sloping guide surface configured to guide and direct the cooking juices contained in said cooking juice drainage channel towards the side collection channel.

9. The cooking appliance according to claim 7, wherein the side collection channel comprises a bottom wall that is sloped and that is configured to guide and direct the cooking juices contained in the side collection channel towards the drainage port.

10. The cooking appliance according to claim 1, wherein the direction of travel is substantially horizontal when the cooking appliance is resting on a horizontal surface.

11. The cooking appliance according to claim 1, wherein the cooking chamber comprises an access opening and the cooking appliance comprises a door configured to be movable between a closed position which closes the access opening and prevents access to the cooking plate, and an open position which frees up the access opening and allows the cooking plate to be moved between the first plate position and the second plate position.

12. A cooking appliance according to claim 1, further comprising a fixed separating component arranged between the collection tray and the cooking plate when the cooking plate is in the first plate position, the separating component comprising a through slot configured to allow the cooking juices to drain through the drainage port and towards the collection tray, regardless of the position of the cooking plate.

13. The cooking appliance according to claim 12, wherein the through slot extends in a lengthwise direction substantially parallel to the direction of travel, so that the drainage port is located plumb with the through slot regardless of the position of the cooking plate.

14. The cooking appliance according to claim 12, wherein the separating component delimits a collection volume configured to collect at least part of the condensates trickling down the inner walls of the cooking chamber.

15. The cooking appliance according to claim 14, wherein the collection volume comprises a bottom wall that extending at least in part opposite the collection tray, the bottom wall comprising a drainage port configured to allow the condensates contained in the collection volume to drain into the collection tray.

16. The cooking appliance according to claim 1, wherein the cooking chamber comprises two deflection components provided respectively on two side walls of the cooking chamber, each deflection component being configured to extend at least in part above the cooking plate and to guide and direct the condensates trickling down the respective side wall of the cooking chamber towards the cooking plate.

17. A cooking appliance according to the claim 16, wherein the cooking plate further comprises two side edges extending substantially parallel to the direction of travel, each deflection component being configured to extend at least in part above a respective side edge and to allow the condensates flowing over said deflection component to drain onto the respective side edge.
